(19) United States
(12) Patent Application Publication
(10) Pub. No.: US 2017/0045673 A1
(43) Pub. Date: Feb. 16, 2017

(54) BACKLIGHT UNIT AND DISPLAY APPARATUS

(71) Applicant: SAMSUNG ELECTRONICS CO., LTD., Suwon-si (KR)

(72) Inventors: A Rum LEE, Wonju-si (KR); Kwan Sik MIN, Gunpo-si (KR)

(73) Assignee: SAMSUNG ELECTRONICS CO., LTD., Suwon-si (KR)

(21) Appl. No.: 15/180,533

(22) Filed: Jun. 13, 2016

(30) Foreign Application Priority Data
Aug. 11, 2015 (KR) 10-2015-0112998

(51) Int. Cl. F21V 8/00

(52) U.S. Cl. CPC G02B 6/0056; G02B 6/0055; G02B 6/0025; G02B 6/005

(57) ABSTRACT

Disclosed herein are a backlight unit and a display apparatus. The backlight unit includes a light guide plate and a reflective polarizer. The reflective polarizer polarizes a first light to a first polarizing axis direction and reflects the first light, the first light being from a direction oblique to a front surface of the light guide plate. The reflective polarizer polarizes a second light to a second polarizing axis direction, which is different from the first polarizing axis direction, and transmits the second light, the second light being from a direction orthogonal to the front surface of the light guide plate.

### CROSS-REFERENCE TO RELATED APPLICATION

This application claims priority from Korean Patent Application No. 10-2015-0112998, filed on Aug. 11, 2015, in the Korean Intellectual Property Office (KIPO), the disclosure of which is incorporated herein by reference in its entirety.

### BACKGROUND

1. Field

Apparatuses and methods consistent with exemplary embodiments relate to a backlight unit and a display apparatus.

2. Description of the Related Art

A display apparatus is the kind of output apparatus configured to convert electrical information that is acquired or stored into visual information to display the visual information to a user. Display apparatuses have been widely used in various fields, e.g. home and offices.

The display apparatus may output an image to the outside by using display means. The display means may include Cathode Ray Tube (CRT), Liquid Crystal Display (LCD), Light Emitting Diode (LED), Organic Light Emitting Diode (OLED), Active-Matrix Organic Light Emitting Diode, or electronic paper.

For example, the display apparatus may include a television, a variety of audio/video system (A/V system), a computer monitor or a mobile terminal device. The mobile terminal device may include a navigation terminal device, a laptop computer device, a smart phone, a table PC, a personal digital assistant (PDA), or a cellular phone. In addition, devices configured to display a stationary image or a moving image and used in an indoor environment or an industrial site may be included in the display apparatus.

### SUMMARY

It is an aspect of the present disclosure to provide a backlight unit and a display apparatus having high visibility without the need for a separate power source to realize a transparent state in a transparent display apparatus.

Additional aspects of the present disclosure will be set forth in part in the description which follows and, in part, will be obvious from the description, or may be learned by practice of the present disclosure.

One or more embodiments relate to a backlight unit including a light guide plate and a reflective polarizer. The reflective polarizer is configured to polarize a first light to a first polarizing axis direction and reflect the first light, the first light being from a direction oblique to a front surface of the light guide plate. The reflective polarizer is also configured to polarize a second light to a second polarizing axis direction, which is different from the first polarizing axis direction, and transmit the second light, the second light being from a direction orthogonal to the front surface of the light guide plate.

According to some embodiments, the backlight unit further includes a light source configured to emit the first light and allow the first light to be directed toward a side surface of the light guide plate.

Some embodiments include a light diffuser provided between the light source and the light guide plate, and configured to diffuse the first light.

In some embodiments, the reflective polarizer polarizes the first light to the first polarizing axis direction and then reflects the first light to the inside of the light guide plate when the first light is incident to a first surface toward a direction of the light guide plate.

According to some embodiments, the reflective polarizer polarizes the second light to the second polarizing axis direction, which is different from the first polarizing axis direction, and then allows the second light to be incident to the inside of the light guide plate when the second light is incident to a second surface placed in an opposite side to the first surface.

In some embodiments, the second surface of the reflective polarizer is exposed to the outside.

Some embodiments include wherein the light guide plate includes an emission surface as the front surface configured to emit a first light, which is polarized, to a direction of a display panel, wherein the reflective polarizer is installed in a rear surface of the light guide plate on an opposite side to the emission surface.

In some embodiments, the light guide plate includes a disperser formed in the emission surface of the light guide plate and configured to disperse the first light incident to the light guide plate, and allow the first light to be toward the direction of the reflective polarizer.

Some embodiments include an optical plate provided between the light guide plate and the reflective polarizer.

According to some embodiments, the optical plate include at least one of a quarter wave plate configured to generate an optical path difference between two polarization components of the first light or the second light, and a low reflection sheet configured to reduce a reflectivity degree of the first light incident.

One or more embodiments disclose a display apparatus include a light guide plate; and a reflective polarizer. The reflective polarizer is configured to polarize a first light to a first polarizing axis direction and then reflect the first light, the first light being from a direction oblique to a front surface of the light guide plate. The reflective polarizer is configured to polarize a second light to a second polarizing axis direction, which is different from the first polarizing axis direction, and then transmit the second light, the second light being from a direction orthogonal to the front surface of the light guide plate.

According to some embodiments, the display apparatus further includes a display panel unit to which a first polarized light or a second polarized light passing through the light guide plate and being polarized is incident.

Some embodiments include a polarizer configured to perform a polarization in a polarizing axis direction identical to the second polarized light.

In some embodiments, the display panel unit displays an image when a first light is emitted from the light source according to the application of the power, and display the second light by transmitting the second light when the power is not applied to the light source.

According to some embodiments, the display apparatus comprises a cellular phone, a smart phone, a tablet PC, a computer monitor device, a lap top, a navigation terminal device, a personal digital assistant device, an outdoor advertising board, a window of a vehicle, or a window of a building.

One or more embodiments relate to a backlight unit having a light guide plate provided with an emission surface configured to emit a light to the outside; and a reflective polarizer provided in a way that a first surface contacts a rear surface of the light guide place, the rear surface being opposite to the emission surface. When the first light passing through the light guide plate is incident to the first surface, the reflective polarizer is configured to polarize the incident first light to the first polarizing axis direction and then reflect the first light to the inside of the light plate guide.

According to some embodiments, the backlight unit includes wherein the reflective polarizer polarizes a second light to a second polarizing axis direction and then transmits the second light when the second light is incident to the second surface that is on an opposite side to the first surface.

### BRIEF DESCRIPTION OF THE DRAWINGS

These and/or other aspects of the present disclosure will become apparent and more readily appreciated from the following description of the embodiments, taken in conjunction with the accompanying drawings of which:

FIG. 1 is a view schematically illustrating a backlight unit in accordance with an embodiment of the present disclosure;

FIG. 2 is a lateral view of a backlight unit in accordance with an embodiment of the present disclosure;

FIGS. 3A to 3C are views illustrating polarization of light;

FIG. 4 is a view illustrating reflection of a first light in a reflective polarizer;

FIG. 5 is a view illustrating transparency of a second light in a reflective polarizer;

FIG. 6 is a lateral view illustrating a reflective polarizer in accordance with an embodiment of the present disclosure;

FIG. 7A is a view illustrating an example of a light guide plate provided with a light disperser;

FIG. 7B is a view illustrating an example of a case in which an optical plate is formed in a reflective polarizer;

FIG. 8A is a lateral view illustrating a backlight unit provided with a light disperser in accordance with an embodiment of the present disclosure;

FIG. 8B is a lateral view illustrating a backlight unit provided with a light disperser in accordance with another embodiment of the present disclosure;

FIG. 9 is a view illustrating a process of emitting a light from a backlight unit when a first light is irradiated from a light source;

FIG. 10 is a view illustrating a process of emitting a light from a backlight unit when a first light is not irradiated from a light source;

FIG. 11 is a view illustrating an exterior of a display apparatus in accordance with an embodiment of the present disclosure;

FIG. 12 is an exploded-perspective view illustrating a display apparatus in accordance with an embodiment of the present disclosure;

FIG. 13 is a cross-sectional view illustrating a display apparatus in accordance with an embodiment of the present disclosure;

FIG. 14 is a view illustrating a display panel in accordance with an embodiment of the present disclosure;

FIG. 15 is a first view illustrating an operation of liquid crystal;

FIG. 16 is a second view illustrating an operation of liquid crystal;

FIG. 17 is a view illustrating a process in which a first polarized light is incident to a display panel when a first light is irradiated from a light source;

FIG. 18 is a view illustrating an operation of liquid crystal when an image is displayed according to a first polarized light;

FIG. 19 is another view illustrating an operation of liquid crystal when an image is displayed according to a first polarized light;

FIG. 20 is a view illustrating an image that is displayed when a first light is emitted from a light source;

FIG. 21 is a view illustrating a process in which a second polarized light is incident to a display panel when a second light is incident to a background;

FIG. 22 is another view illustrating an operation of liquid crystal when an image is displayed according to a second polarized light;

FIG. 23 is another view illustrating an operation of liquid crystal when an image is displayed according to a second polarized light; and

FIG. 24 is a view illustrating an image that is displayed when a second polarized light is incident.

### DETAILED DESCRIPTION

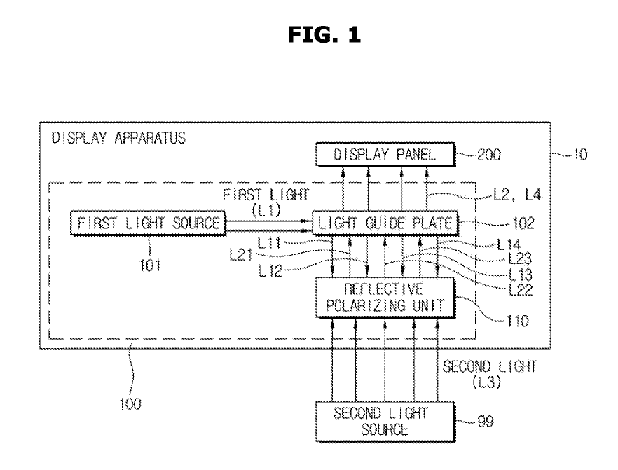

Hereinafter embodiments of a backlight unit will be described with reference to FIGS. 1 to 10.

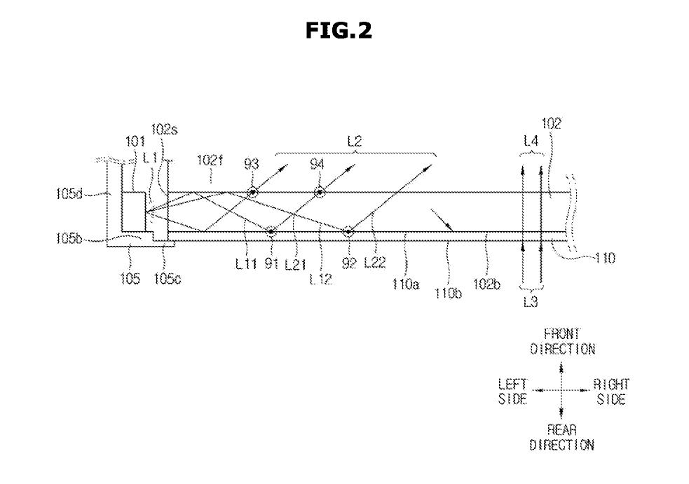

FIG. 1 is a view schematically illustrating a backlight unit in accordance with an embodiment of the present disclosure and FIG. 2 is a lateral view of a backlight unit in accordance with an embodiment of the present disclosure. For convenience of description, with respect to FIG. 2, an upper side direction of the drawings is defined as a front direction, and a lower side direction of the drawings is defined as a rear direction. A direction that is perpendicular to a line extending from a front direction to a rear direction is defined as a lateral direction. The lateral direction includes a right side direction and a left side direction, wherein the right side direction is defined as the 3 o'clock direction and the left side direction is defined as the 9 o'clock direction when a front direction represents the 12 o'clock direction. The definition of the direction is merely for convenience of the description, and the direction may be differently defined by the designer.

As illustrated in FIG. 1, a backlight unit 100 may be provided to be installable in a display apparatus 10, and may emit a certain light (L2 and L4) that is incident to a display panel 200 of the display apparatus 10. The backlight unit 100 may generate a first light (L1) by using a first light source 101 that is additionally provided, and provide a first polarized light (L2), which is acquired by polarizing a generated first light (L1), to the display panel 200. In addition, the backlight unit 100 may provide a second polarized light (L4), which is acquired by polarizing a second light (L3) incident from a second light source 99 that is additionally provided in the outside of the display apparatus 10, to the display panel 200. The second light source 99 may represent a light source separate from the display apparatus 10 and the backlight unit 100, e.g. the sun, a variety of lightings, and a general object reflecting a light emitted from the sun or lightings. The second light (L3) may represent a light emitted from the second light source 99 and include a natural light, e. g. sunlight.

To provide the first polarized light (L2) and the second polarized light (L4) to the display panel 200, according to an embodiment, the backlight unit 100 may include a first light source 101 configured to emit the first light (L1), a light guide plate 102 to which a light (L1) emitted from the first light source 101 is incident, and a reflective polarizer 110 configured to reflect all or a part of a light traveling in the light guide plate 102.

The first light source 101 may emit the first light (L1) and allow the first light (L1) to be incident to the light guide plate 102. The first light (L1) emitted from the first light source 101 may include a white-based light or a blue-based light. When power is applied from the outside, the first light source 101 may generate and emit the first light (L1) and when power is blocked, the first light source 101 does not emit light. The first light source 101 may be implemented by light sources such as an incandescent bulb, a halogen lamp, a fluorescent lamp, a sodium lamp, a mercury lamp, a fluorescent mercury lam, a xenon lamp, an arc lamp, a neon tube lamp, an electroluminescent lamp (EL lamp), a Light Emitting Diode (LED), a Cold Cathode Fluorescent Lamp (CCFL), or an External Electrode Fluorescent Lamp (EEFL). In addition the first light source 101 may be implemented by a variety of lighting devices configured to emit a white-based light or a blue-based light.

As illustrated in FIG. 2, the first light source 101 may be installed in a housing 105 configured to support the first light source 101. The housing 105 may include a support 105b supporting the first light source 101 and the first light source 101 may be supported by the housing 105 since the first light source 101 is placed in one surface in a front direction of the support 105b. Meanwhile, the housing 105 may be provided with an extension 105d, and the extension 105d may be provided in a direction opposite to the light guide plate 102 with respect to the first light source 101. A certain reflecting material may be installed on an external surface of the extension 105d by the application or the deposition method so that the first light (L1) emitted from the first light source 101 is toward the light guide plate 102.

The first light (L1) emitted from the first light source 101 may be incident to the light guide plate 102, particularly incident to a side surface 102s.

The light guide plate 102 may be configured to induce and diffuse the first light (L1) emitted from the first light source 101 or the second light (L3) incident via the reflective polarizer 110.

The light guide plate 102 may reflect the first light (L1) emitted from the first light source 101 or the second light (L3) incident via the reflective polarizer 110 by at least once in the inside and then diffuse the first light (L1) or the second light (L3) so that the light (L2 and L4) are evenly provided in all over the display panel 200. The light guide plate 102 may be manufactured of a material having high light transmittance. For example, the light guide plate 102 may be manufactured of synthetic resins, e.g. Poly Methyl Methacrylate (PMMA) or Poly Carbonate (PC). The light transmittance of the material used for the light guide plate 102 may be more than approximately 89%, but the light transmittance of the material used for the light guide plate 102 may be determined according to a designer's choice.

The light guide plate 102 may have a flat plate shape. The light guide plate 102 may include an emission surface 102f disposed in a front direction of the light guide plate 102 and a rear surface 102b disposed in a rear direction of the light guide plate 102 wherein the emission surface 102f and the rear surface 102b may be disposed to face to each other. The light guide plate 102 may include a side surface 102s connecting one boundary of the emission surface 102f to one boundary of the rear surface 102b, which is in the same direction of the one boundary of the emission surface 102f. The emission surface 102f of the light guide plate 102 may be configured to emit the light (L2 and L4) and the rear surface 102b of the light guide plate 102 may be provided to allow the reflective polarizer 110 to be installed. When the light guide plate 102 is installed in the display apparatus 10, the display panel 200 may be in the front direction of the light guide plate 102, and the light (L2 and L4) emitted from the light guide plate 102 may be incident to the rear surface of the display panel 200. The display panel 200 may display a stationary image or a moving image by using the incident light (L2 and L4). The side surface 102s of the light guide plate 102 may be provided to allow the light (L1) emitted from the first light source 101 to be incident. The side surface 102s of the light guide plate 102 may have a shape to allow the light (L1) to be easily incident.

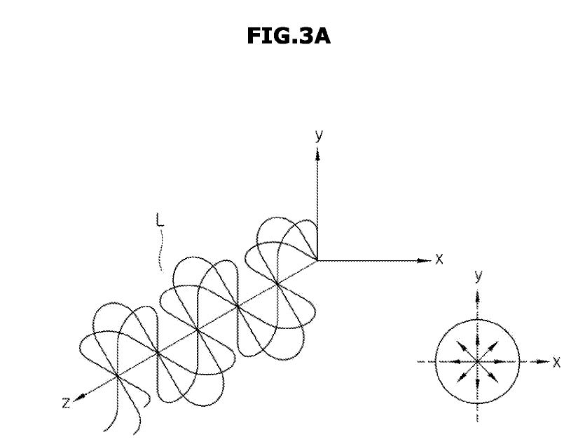

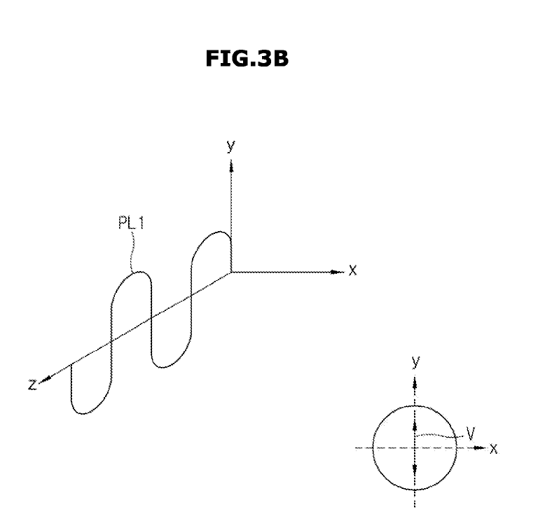

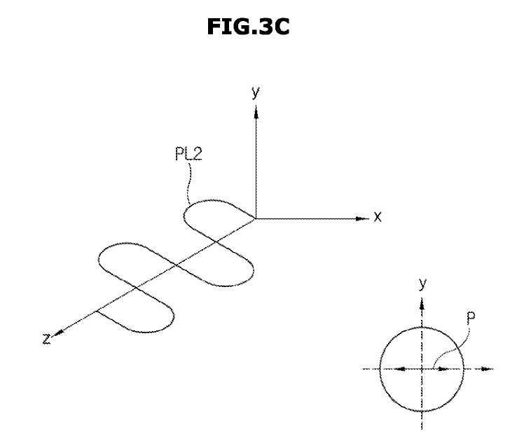

FIGS. 3A to 3C are views illustrating polarization of light.

A light (L) may be transmitted since an electric field and a magnetic field vibrate wherein the electric field and the magnetic field are crossing at right angles. In this case, as illustrated in FIG. 3A, the electric field and the magnetic field of the light (L) may vibrate and travel in a travel direction (Z axis) and a perpendicular direction (X axis and Y axis). In general, the light (L) may have a state in which lights vibrating in every perpendicular direction to the travel direction (Z axis) are mixed.

In this case, when the light (L) passes through a polarization filter, the light may include an electric field or a magnetic field that vibrates on only a certain plane surface perpendicular to the travel direction (Z axis), such a light may represent a polarized light.

A polarized light (PL1 and PL2) may travel while vibrating in a certain direction (v and p). For example, as illustrated in FIG. 3B, the polarized light (PL1 and PL2) may vibrate (v) and move on only a vertical plane that is formed by the vertical axis (Y axis) and the travel direction (Z axis) or as illustrated in FIG. 3C the polarized light (PL1 and PL2) may vibrate (p) on only a horizontal plane, which is formed by the horizontal axis (X axis) and the travel direction (Z axis), and move in the travel direction (Z axis). Hereinafter for convenience of the description, an axis in which the polarized light (PL1 and PL2) vibrate, e.g. the Y axis of FIG. 3A or the X axis of FIG. 3B, may be defined as a polarizing axis. In addition, a polarized light (PL1) vibrating (v) and traveling in the vertical plane, that is a polarized light in which a polarizing axis is the vertical direction (Y axis), may referred to as a vertical polarized light, and a polarized light (PL2) vibrating (p) and traveling in the horizontal plane, that is a polarized light in which a polarizing axis is the horizontal direction (X axis), may referred to as a horizontal polarized light.

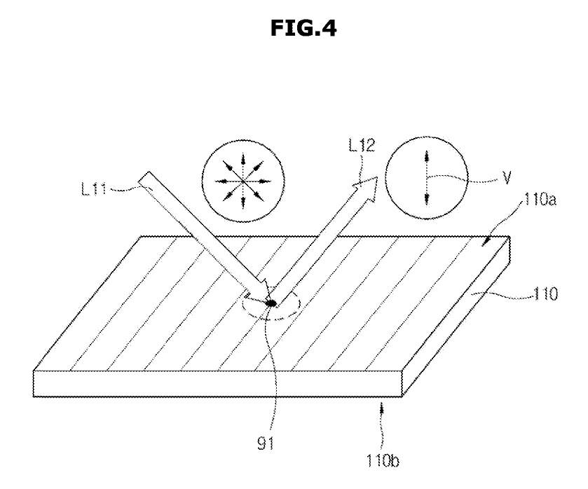

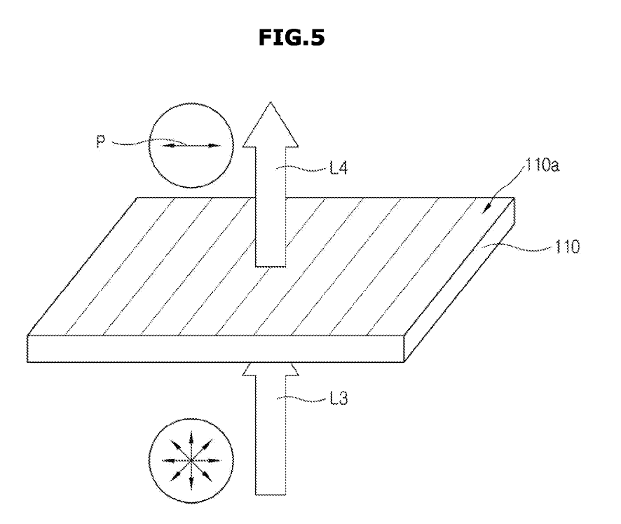

FIG. 4 is a view illustrating reflection of a first light of a reflective polarizer and FIG. 5 is a view illustrating transparency of a second light of a reflective polarizer.

The reflective polarizer 110 may be installed in the rear surface 102b of the light guide plate 102. The reflective polarizer 110 may polarize the first light (L1), which is incident from the light guide plate 102, and then reflect the first light (L1) to a first polarizing axis (v) direction. In addition, the reflective polarizer 110 may polarize a light incident from the second light source 99 provided in the outside of the display apparatus 10 and then transmit the light to a second polarizing axis. The first polarizing axis (v) and the second polarizing axis (p) may be different from each other. In this case, the first polarizing axis (v) and the second polarizing axis (p) may cross at right angles. Particularly, a polarizing axis of any one of the first polarizing axis (v) and the second polarizing axis (p) may be the vertical direction (Y axis) and a polarizing axis of the other of the first polarizing axis (v) and the second polarizing axis (p) may be the horizontal direction (X axis).

As illustrated in FIGS. 2 to 4, the first light (L1) incident to the side surface 102s of the light guide plate 102 may travel to a rear surface direction of the light guide plate 102 while traveling inside of the light guide plate 102. A first light (L11 and L21) travelling to the rear surface direction may pass through the rear surface of the light guide plate 102 and then incident to the reflective polarizer 110. Particularly, the first light (L11 and L21) may be incident to at least one point 91 and 92 of a front surface 110a that is one surface of the front direction of the reflective polarizer 110. When the first light (L11 and L21) is incident to at least one point 91 and 92 of the front surface 110a, the reflective polarizer 110 may polarize the first light (L11 and L21) incident to the at least one point 91 and 92 and emit a first polarized light (L12 and L22). In this case, the first polarized light (L12 and L22) emitted from the reflective polarizer 110 may vibrate and travel to the first polarizing axis, e.g. the vertical polarizing axis direction (v). As illustrated in FIG. 2, the first polarized light (L12 and L22) may be introduced to the inside of the light guide plate 102 and then emitted to the outside (L2) by passing through at least one point 93 and 94 of the emission surface 102f of the light guide plate 102, or the first polarized light (L12 and L22) may be incident to the first light source 101 again after being reflected to the light guide plate 102 again. Accordingly, in the light guide plate 102, the first polarized light (L2) that vibrates to the first polarizing axis direction (v) may be emitted.

As illustrated in FIGS. 2 to 4, the second light (L3), which is generated in the second light source 99 or which is transferred after being reflected, may be incident to a rear surface 110b that is one surface in the rear direction of the reflective polarizer 110. In this case, the reflective polarizer 110 may polarize and transmit the second light (L3) incident to the rear surface 110b, thereby emitting the second polarized light (L4). The second polarized light (L4) may be a light that vibrates and travels to the second polarizing direction, e.g. the horizontal polarizing axis direction (p). In other words, the reflective polarizer 110 may polarize the second light (L3), which is incident to the reflective polarizer 110b, to a polarizing axis direction that is different from the first light (L11 and L12). The second polarized light (L4) that passes through the reflective polarizer 110 may be incident to the rear surface 102b of the light guide plate 102 by passing through the emission surface 102f of the reflective polarizer 110, and the light guide plate 102 may transmit the second polarized light (L4) incident to the rear surface 102b and emit the second polarized light (L4) to the outside.

The reflective polarizer 110 may be provided to be set on a protrusion 105c of the housing 105 protruded toward the reflective polarizer 110. In this case, since only a part of a surrounding of the reflective polarizer 110 is placed on the housing 105c, the other part of the reflective polarizer 110 may be exposed to the outside via an opening 105a formed by the protrusions 105c. Accordingly, the second light (L3) delivered from the external light source 99 may be incident to the other part of the reflective polarizer 110. Therefore, as well as the first light (L1) emitted from the first light source 101, the second light (L3) delivered from the second light source 99 may be incident to the reflective polarizer 110.

The reflective polarizer 110 may be implemented by Dual Brightness Enhancement Film (DBEF™ film) having a stacked structure, or by diffusive reflective polarization film (DRPF). The dual brightness enhancement film may have a stacked structure in which an isotropic film and an anisotropic film are crossed over each other, and may reflect an incident light after polarizing the incident light, or transmit the incident light by using the stacked structure. The diffusive reflective polarization film may include at least one film and a material which is formed inner side of the at least one film and has a refractive index that is different from that of the film. Since a light is reflected or refracted by the material having a refractive index that is different from that of the film, the diffusive reflective polarization film may polarize an incident light and then reflect or transmit the light. The reflective polarizer 110 may be implemented by wire grid polarizer, or cholesteric liquid crystal polarizer (CLC polarizer). Nano wire grid polarizer may be manufactured by using nano imprinting technology, and the nano wire grid polarizer may be configured to reflect a light, which is not parallel to the second polarizing axis among an incident light, to the first polarizing axis and transmit a light, which is parallel to the second polarizing axis. The CLD polarizer may use a principal in which a cholesteric liquid crystal is configured to selectively reflect a light, and may represent a polarizer capable of transmitting a polarized light in a certain direction and reflect a polarized light in other direction by using a cholesteric liquid crystal that is spiral-twisted. The reflective polarizer 110 is not limited thereto, and thus a variety of films or sheets, which is configured to polarize a light incident to one surface in the first polarizing axis direction and reflect the polarized light, and configured to polarize a light incident to the other surface in the second polarizing axis direction and transmit the polarized light, may be used as the reflective polarizer 110.

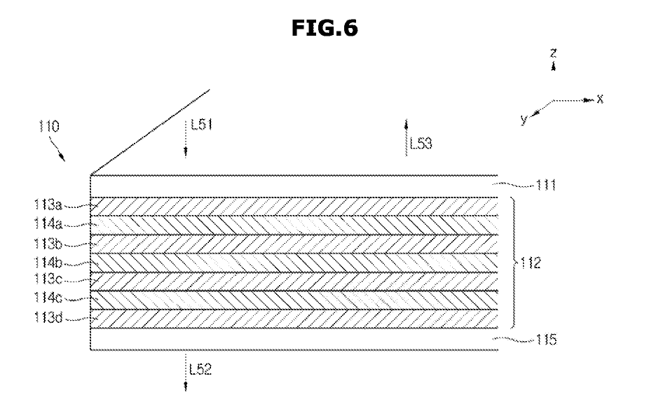

Hereinafter an example of the reflective polarizer 110 will be described in detail. FIG. 6 is a lateral view illustrating a reflective polarizer in accordance with an embodiment of the present disclosure.

As illustrated in FIG. 6, the reflective polarizer 110 may include a first diffusion layer 111, a reflective polarizing layer 112, and a second diffusion layer 115 which are stacked in sequence.

The first diffusion layer 111 may be configured to diffuse an incident light or an emitted light. For example, when a light (L51) is incident from the outside, the first diffusion layer 111 may diffuse the incident light (L51) and deliver the incident light (L51) to the reflective polarizing layer 112. The first diffusion layer 111 may be implemented by at least one diffusion plate. In addition, the first diffusion layer 111 may provide a path in which a light (L53) reflected by the reflective polarizing layer 112 is emitted to the outside.

The reflective polarizing layer 112 may include a first polymer 113a, 113b, 113c, and 113d, and a second polymer 114a, 114b and 114c that is different from the first polymer 113a, 113b, 113c, and 113d. The first polymer 113a, 113b, 113c, and 113d and the second polymer 114a, 114b and 114c may be alternately stacked with each other. At least one of the first polymer 113a, 113b, 113c, and 113d and the second polymer 114a, 114b and 114c may include the isotropy, and the other thereof may include the anisotropy. In other words, the first polymer 113a, 113b, 113c, and 113d and the second polymer 114a, 114b and 114c may be provided to have the same refractive index or a refractive index, which is different from each other, according to each an axis direction, e.g. a X axis direction and a Y axis direction wherein the X axis direction and the Y axis direction cross at right angles. For example, the first polymer 113a, 113b, 113c, and 113d and the second polymer 114a, 114b and 114c may have the same refractive index in the X axis direction although the first polymer 113a, 113b, 113c, and 113d and the second polymer 114a, 114b and 114c may have a refractive index, which is different from each other in the Y axis direction. Since a material having the isotropy and a material having the anisotropy are crossed over each other and overlapped with each other, the reflective polarizing layer 112 may reflect a light in a certain polarizing axis and transmit a light in another polarizing axis. The first polymer 113a, 113b, 113c, and 113d and the second polymer 114a, 114b and 114c may be acquired by polymerizing at least one monomer.

The second diffusion layer 115 may perform a function of diffusing a light that is the same function of the first diffusion layer 111. For example, when a light (L52) is delivered from the reflective polarizing layer 112, the second diffusion layer 115 may diffuse the delivered light and then emit the delivered light to the outside.

The first diffusion layer 111 and the second diffusion layer 115 may provide a function corresponding to a position of an incident light. Particularly, when a light is incident on the contrary to as illustrated in FIG. 6, the second diffusion layer 115 may provide the above-mentioned function of the first diffusion layer 111, and the first diffusion layer 111 may provide the above-mentioned function of the second diffusion layer 115.

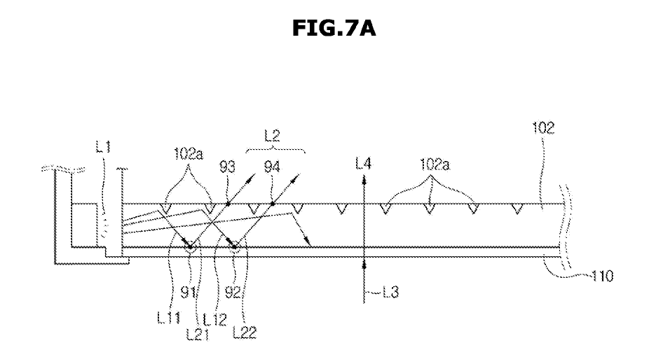

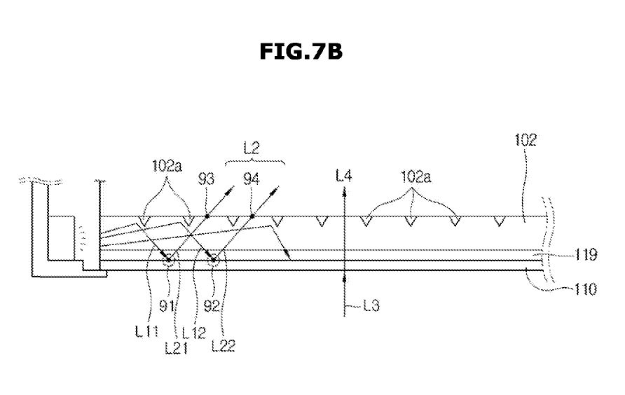

FIG. 7A is a view illustrating an example of a light guide plate provided with a light disperser.

As illustrated in FIG. 7A, the light guide plate 102 may further include at least one light disperser 102a. The light disperser 102a may be provided inside of the light guide plate 102, and may diffuse the first light (L11 and L12) that travels inside of the light guide plate 102 to divert the first light (L11 and L12) so that the first light (L11 and L12) is incident to the reflective polarizer 110. Accordingly, the first light (L11 and L12) may be incident to the reflective polarizer 110 more quickly.

The light disperser 102a may be provided in one surface of the light guide plate 102, particularly, in one surface in the front direction to which the light (L2 and L4) is emitted, that is the emission surface 102f. The light disperser 102a may be formed on the emission surface 102f of the light guide plate 102 to have a certain pattern. The pattern of the light disperser 102a may be determined to have various shapes according to a designer's choice.

The light disperser 102a may be provided in one surface of the light guide plate 102 by using a variety of methods. For example, the light disperser 102a may be implemented by a protrusion protruding toward the inside of the light guide plate 102, or may be implemented by cutting the emission surface 102f of the light guide plate 102, e.g. a groove formed by a v-cutting technology. In addition, a variety of technologies configured to diffuse the first light (L11 and L12) that travels in the light guide plate 102 may be used as the light disperser 102a.

FIG. 7B is a view illustrating an example of a case in which an optical plate is formed in a reflective polarizer.

At least one optical plate 119 may be formed between the light guide plate 102 and the reflective polarizer 110. The optical plate 119 may be installed on one surface 110a in the front direction of the reflective polarizer 110 so as to be stacked on the reflective polarizer 110.

The optical plate 119 may change optical characteristics of the first polarized light (L2) or the second polarized light (L4) emitted from the reflective polarizer 110, or prevent an excessive reflection of a light by the reflective polarizer 110. The optical plate 119 may prevent a direct connection between the light guide plate 102 and the reflective polarizer 110 to protect the light guide plate 102 and the reflective polarizer 110.

The optical plate 119 may include at least one of a low reflection sheet configured to reduce the reflectivity of the incident first light (L11 and L12), and a quarter wave plate configured to change polarization characteristics of the first polarized light (L21 and L22) that is reflected and the second polarized light (L4) that is transmitted. The low reflection sheet may absorb a part of the first light (L11 and L12) incident to the light guide plate 102 or a part of the first polarized light (L21 and L22) emitted from the reflective polarizer 110. The quarter wave plate may generate an optical path difference between the two polarization components. Accordingly, when the first polarized light (L21 and L22) or the second polarized light (L4) is an a linearly polarized light, the quarter wave plate may convert the linearly polarized light into a circularly polarized light, or when the first polarized light (L21 and L22) or the second polarized light (L4) is an a circularly polarized light, the quarter wave plate may convert the circularly polarized light into a linearly polarized light. The quarter wave plate may be implemented by muscovite, synthetic resin or celluloid.

The optical plate 119 may be implemented by a single sheet by using any one of the low reflection sheet and the quarter wave plate or by stacking a plurality of sheets. In addition, the optical plate 119 may be formed by using a composite sheet in which a function of each sheet is composited.

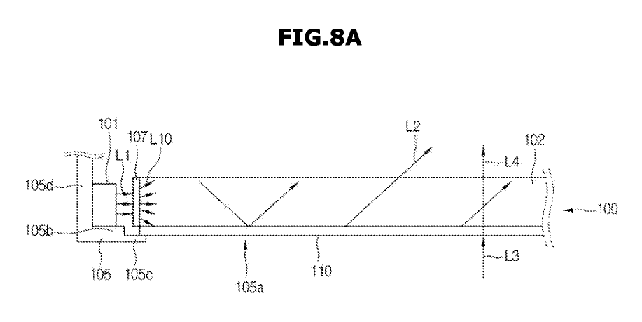

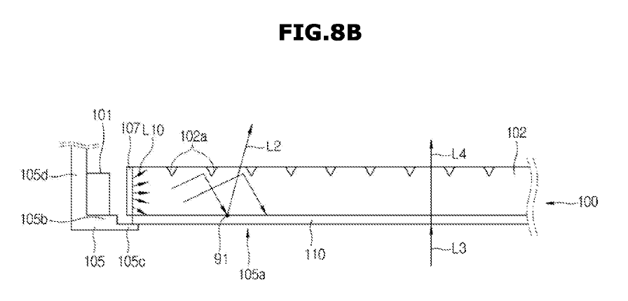

FIG. 8A is a lateral view illustrating a backlight unit provided with a light disperser in accordance with an embodiment of the present disclosure.

As illustrated in FIG. 8A, according to an embodiment of the present disclosure, the backlight unit 100 may include a first light source 101 emitting a first light (L1), a light diffuser 107 diffusing the light (L1) emitted from the first light source 101, a light guide plate 102 upon which a light (L10) that is diffused by the light diffuser 107 is incident, and a reflective polarizer 110 reflecting all or a part of a light that travels inside of the light guide plate 102.

The first light source 101, the light guide plate 102, and the reflective polarizer 110 are above-described, and thus hereinafter the description thereof will be omitted.

The light diffuser 107 may diffuse the light (L1) emitted from the first light source 101 and then incident the diffused light to the side surface 102s of the light guide plate 102. The light diffuser 107 may diffuse the incident light (L1) to convert a point light source or a line light source into a surface light source so that the light (L10) may be incident to be widely spread to all over the side surface 102s of the light guide plate 102. The light diffuser 107 may be provided between the first light source 101 and the light guide plate 102. In this case, the light diffuser 107 may be formed between the first light source 101 and the light guide plate 102 by being applied or attached to the side surface 102s of the light guide plate 102.

The light diffuser 107 may have a shape of a certain film. For example, the light diffuser 107 may be implemented in a way in which a certain light scattering particle is built in a matrix formed of a polymethyl methacrylate resin and a polycarbonate. The light scattering particle built in a matrix may include a variety of particles capable of scattering an incident light, e.g. zinc oxide (ZnxOx), titanium oxide (TixOx) or silicon oxide (SixOx).

The first light (L10) diffused by the light diffuser 107 may be polarized by the reflective polarizer 110 while traveling inside of the light guide plate 102, reflected after being changed into the first polarized light (L12 and L22), and emitted to the outside, e.g. the display panel 200 by passing through the light guide plate 102.

FIG. 8B is a lateral view illustrating a backlight unit provided with a light disperser in accordance with another embodiment of the present disclosure.

As illustrated in FIG. 8B, according to another embodiment of the present disclosure, a backlight unit 100 may include a first light source 101 emitting a first light (L1), a light diffuser 107 diffusing the light (L1) emitted from the first light source 101, a light guide plate 102 upon which a light (L10) that is diffused by the light diffuser 107 is incident and in which a light disperser 102a is formed on one surface 102f thereof, and a reflective polarizer 110 reflecting all or a part of a light that travels inside of the light guide plate 102.

A light (L1) emitted from the first light source 101 may be diffused by the light diffuser 107 installed between the first light source 101 and the light guide plate 102 and then incident to the side surface 102s of the light guide plate 102. A first light (L11 and L12) that is diffused by the light diffuser 107 and travels inside of the light guide plate 102 may be scattered by the light disperser 102a and then incident to the reflective polarizer 110. Accordingly, the first light (L11 and L12) may be relatively quickly incident to the reflective polarizer 110.

A detail description of the first light source 101, the light guide plate 102, the light disperser 102a, the light diffuser 107, and the reflective polarizer 110 are already described and thus it will be omitted.

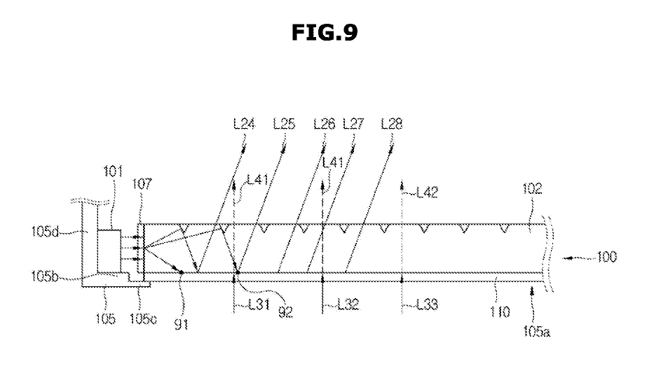

FIG. 9 is a view illustrating a process of emitting a light from a backlight unit when a first light is irradiated from a light source.

Referring to FIG. 9, when the first light (L1) is emitted from the first light source 101, the first light (L1) may be directly incident to the side surface 102s of the light guide plate 102 or incident to the side surface 102s of the light guide plate 102 after being diffused by passing through the light diffuser 107. The first light (e.g. L10), which travels inside of the light guide plate 102, may be directly incident to a point 91 and 92 of the reflective polarizer 110 or may be incident to the point 91 and 92 of the reflective polarizer 110 after being reflected inside of the light guide plate 102 at least once. When the light disperser 102a is further provided in the light guide plate 102, the first light (e.g. L10), which travels inside the light guide plate 102, may be directly incident to a point 91 and 92 of the reflective polarizer 110 after being diffused by the light disperser 102a or may be incident to the point 91 and 92 of the reflective polarizer 110 after being reflected in the light guide plate 102 at least once.

The reflective polarizer 110 may polarize the incident first light (e.g. L10) to the first polarizing axis direction, and emit the acquired first polarized light (L24 to L28) to the inside of the light guide plate 102. The emitted first polarized light (L24 to L28) may directly pass through the light guide plate 102 and then emitted to the outside or emitted to the outside via the emission surface 102f of the light guide plate 102 after being reflected at least one time inside of the light guide plate 102.

A second light (L31 to L33) delivered from the second light source 99 may be incident to the rear surface 110b of the reflective polarizer 110. The second light (L31 to L33) may be polarized to the second polarizing axis direction by the reflective polarizer 110, and thus a second polarized light (L41 to L43) may be emitted from the reflective polarizer 110. The second polarized light (L41 to L43) emitted by the reflective polarizer 110 may travel to the inside of the light guide plate 102 and then directly emitted to the outside via the emission surface 102f of the light guide plate 102 or emitted to the outside via the emission surface 102f of the light guide plate 102 after being reflected at least one time in the inside of the light guide plate 102. Since the second polarized light (L41 to L43) comes from the second light (L31 to L33) delivered from the second light source 99, the intensity of the second polarized light (L41 to L43) may be relatively weaker than that of the first polarized light (L24 to L28) coming from the first light (L1) that is emitted from the first light source 101.

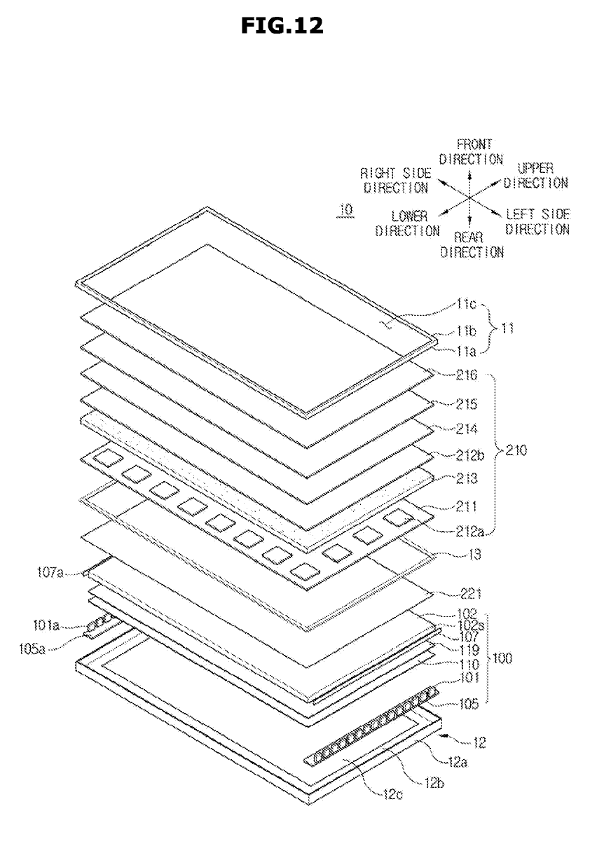

When a polarizer (216 of FIG. 12) provided in the display panel 200 is a polarizing plate configured to polarize a light that is incident to the second polarizing axis direction, the first polarized light (L24 to L28) reflected by the reflective polarizer 110 may pass through a liquid crystal layer (213 of FIG. 12) and then incident to the a polarizer 216. In this case, according to the arrangement of liquid crystal molecules 217 in the inside of the liquid crystal layer 213, a polarizing axis direction of the first polarized light (L24 to L28) may be rotated to be identical to the second polarizing axis direction and thus the first polarized light (L24 to L28) may pass through the a polarizer 216. Therefore, the first polarized light (L24 to L28) reflected by the reflective polarizer 110 may pass through the display panel 200 and then emitted to the outside. On the contrary, since a polarizing axis direction faces to the first polarizing axis direction according to the arrangement of liquid crystal molecules 217, the second polarized light (L41 to L43) may not pass through the a polarizer 216. Therefore, the second polarized light (L41 to L43) passing through the reflective polarizer 110 may be not emitted via the display panel 200. Accordingly, the display panel 200 may display a stationary image or a moving image by using the first polarized light (L24 to L28).

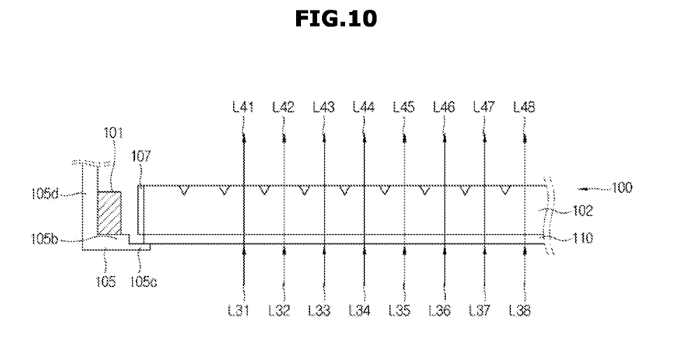

FIG. 10 is a view illustrating a process of emitting a light from a backlight unit when a first light is not irradiated from a light source.

Referring to FIG. 10, since the first light (L1) is not emitted from the first light source 101, a light may be not incident to the side surface 102s of the light guide plate 102. Therefore, the first light (L1) may be not incident to the reflective polarizer 110.

In this case, a second light (L31 to L38) delivered from the second light source 99 may be incident to the rear surface 110b of the reflective polarizer 110. The second light (L31 to L38) may be polarized to the second polarizing axis direction by the reflective polarizer 110. Therefore, in the reflective polarizer 110, the second polarized light (L41 to L48) corresponding to the incident second light (L31 to L38) may be emitted from the reflective polarizer 110. The second polarized light (L41 to L48) emitted by the reflective polarizer 110 may be emitted to the outside via the emission surface 102f of the light guide plate 102.

As mentioned above, when the polarizer 216 provided in the display panel 200 is a polarizing plate configured to polarize a light that is incident to the second polarizing axis direction, a light reflected by the reflective polarizer 110 may be not incident to the polarizer 216 at all or substantially. The second polarized light (L41 to L43) that is delivered by passing through the reflective polarizer 110 may be incident to the polarizer 216 after passing through the liquid crystal layer 213. In this case, when the liquid crystal molecules 217 in the liquid crystal layer 213 are arranged to the direction of the both electrodes (212a and 212b of FIG. 12), the polarizing axis of the second polarized light (L41 to L43) may be not changed and thus the second polarized light (L41 to L43) may still vibrate and travel to the second polarizing axis direction. Therefore, the second polarized light (L41 to L43) passing through the reflective polarizer 110 may pass through the polarizer 216 and then pass through the display panel 200 thereby being emitted to the outside. Accordingly, since a light delivered from the second light source 99 of the outside is provided to a user via the display panel 200, the display panel 200 may be implemented to be transparent.

Hereinafter a display apparatus provided with the above-mentioned backlight unit 110 will be described according to an embodiment.

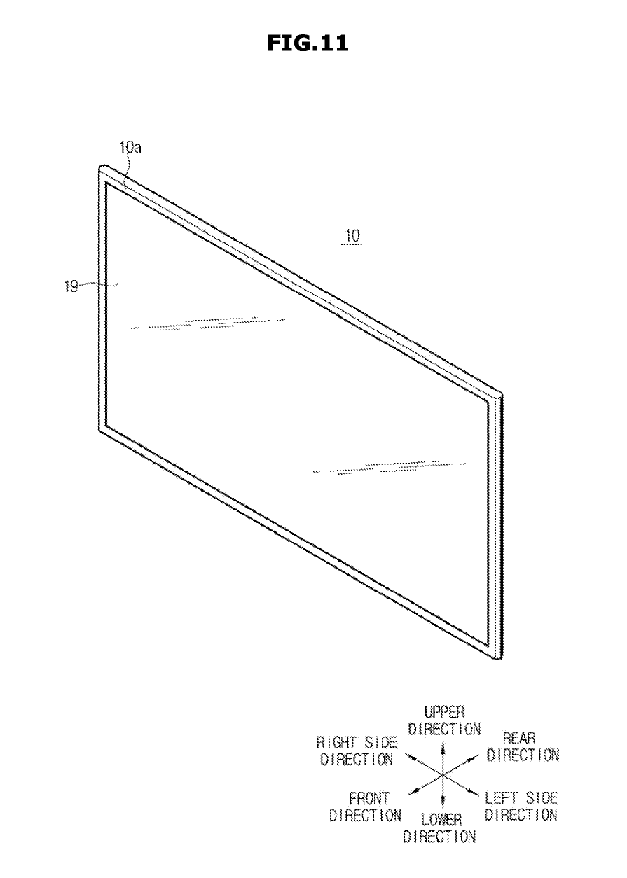

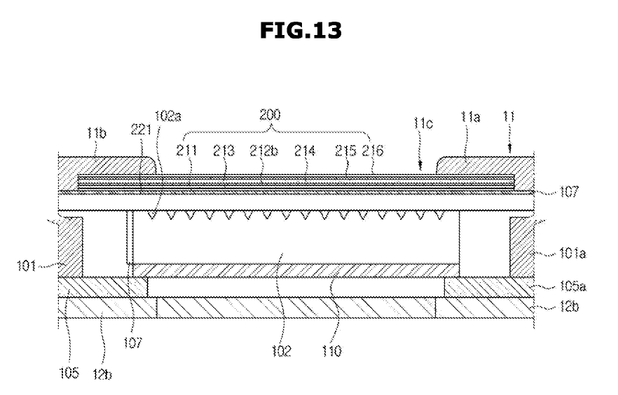

FIG. 11 is a view illustrating an exterior of a display apparatus in accordance with an embodiment of the present disclosure, FIG. 12 is an exploded-perspective view illustrating a display apparatus in accordance with an embodiment of the present disclosure, and FIG. 13 is a cross-sectional view illustrating a display apparatus in accordance with an embodiment of the present disclosure.

Hereinafter for convenience of the description, in the display apparatus 10, a front direction may represent a direction in which an image is displayed and a rear direction may represent a direction opposite to the front direction with respect to the display apparatus 10. In addition, an upper direction may represent an upper direction of the display apparatus 10, and a lower direction may represent a direction opposite to the upper direction. In a state in which the 12 o'clock direction is defined as the front direction when viewing from the upper direction, the 3 o'clock direction may be defined as a right direction, and the 9 o'clock direction may be defined as a left direction.

As illustrated in FIG. 11, the display apparatus 10 may include an exterior housing 10a forming the exterior, and an image display unit 19 in which an image is displayed.

The exterior housing 10a may form an exterior of the display apparatus 10 and include a component to allow the display apparatus 10 to display an image or to perform a variety of functions. The exterior housing 10a may integrally formed or may be formed by combining with a plurality of housings, e. g. a front housing (e.g. 11) and a rear housing 12. In the inside of the exterior housing 10a, an additional middle housing 13 may be further provided.

The image display unit 19 may be installed in the front direction of the exterior housing 10a to display a variety of images to the outside. Particularly, the image display unit 19 may display at least one of a stationary image or a moving image. The image display unit 19 may be implemented by the display panel 200, but is not limited thereto. According to embodiments, the image display unit 19 may be implemented by using the display panel 200 and an additional component, e.g. a touch screen panel that is formed in the front side of the display panel 200.

According to embodiments, the display apparatus 10 may further include a supporting fixture (not shown) and a leg (not shown). The supporting fixture may support the exterior housing 10a and the leg may be connected to the supporting fixture and allow the display apparatus 10 to be stably placed in a variety of locations, e.g. a bottom surface, and an upper surface of the furniture. The supporting fixture or the leg may be detachably installed with each other or detachably installed in the exterior housing 10a. The supporting fixture or the leg may have a variety of shapes according to a designer's choice or may be omitted.

Referring to FIGS. 12 and 13, a display apparatus 10 may include a housing 11 and 12 forming an exterior, a backlight unit 100 providing a light to the display panel 200, and a display panel 200 displaying an image by using a light supplied from the backlight unit 100.

According to an embodiment, the housing 11 and 12 may include a front housing 11 installed in the front direction, and a rear housing 12 installed in the rear direction. According to embodiments, the front housing 11 and the rear housing 12 may be integrally formed or may be separately formed to allow to be coupled to each other.

The front housing 11 may be placed in the most front direction of the display apparatus 10, and may include a fixation support 11b forming a bezel, and a side support 11a extended from an end portion of the fixation support 11b to the rear housing 12. In the front surface of the front housing 11, an opening 11c may be formed. The side support 11a may connect the front housing 11 to the rear housing 12 by being coupled to the rear housing 12. The side support 11a may fix a variety of components to the inside of the display apparatus 10, and may protect the variety of components embedded in the display apparatus 10 from an impact delivered from the lateral direction. The fixation support 11b may be protruded in the direction of the opening 11c to fix the variety of components, e. g. the display panel 200, so as to prevent the related components from being left or being exposed to the outside. The opening 11c may expose the display panel 200 to the outside to allow an image generated by the display panel 200 to be displayed so that a user may watch the image. Particularly, the opening 11c may allow an image, which is formed of a light passing through a polarizer 216, to be exposed to the outside.

The rear housing 12 may be placed in the most rear direction of the display apparatus 10 to form a rear surface and/or a part of a lateral surface of the exterior of the display apparatus 10. The rear housing 12 may include a fixation support 12b and a side support 12a extended from an end portion of the fixation support 12b to the front housing 11. The fixation support 12b of the rear housing 12 may be connected to the fixation support 11b of the front housing 11 so that a variety of components of the display apparatus 10 may be embedded in the display apparatus 10. The fixation support 12b may fix the backlight unit 100 to the inside. An opening 12c may be formed in the rear housing 12. The opening 12c of the rear housing 12 may be provided in the inside of the fixation support 12b to allow a light source incident from the outside to be supplied to the backlight unit 100.

The backlight unit 100 may include at least one light source 101 and 101a, the light guide plate 102 in which a light is incident to the side surface 102s, at least one substrate 105 and 105a, and a reflective polarizer 110 installed in the rear direction of the light guide plate 102.

The at least one light source 101 and 101a may be mounted to be arranged to have a certain pattern in a certain surface of the substrate 105 and 105a. The at least one light source 101 and 101a may be installed in at least one of the left direction and the right direction of the light guide plate 102 so that a light is incident to the opposite surfaces of the light guide plate 102. The at least one light source 101 and 101a may be provided in the opposite surfaces of the light guide plate 102, and in this case, the at least one light source 101 and 101a may be respectively mounted to have a certain pattern on the substrate 105 and 105a installed in the left side and the right side of the light guide plate 102.

The light source 101 and 101a may emit a certain color of a first light. The certain color of the first light may include a light based white or a light based blue. The light based white color may be generated by mixing a plurality of lights having differential wavelength and may represent a light that is indicated as a white color or a similar color. The light based blue color may have an approximately from 400 nm to 500 nm of wavelength, and may represent a light that is indicated as a blue color or a similar color. The first light emitted from the light source 101 may be incident to the side surface 102s of the light guide plate 102.

The light source 101 and 101a may be implemented by a variety of emitting light means, e.g. an incandescent lamp, a halogen lamp, a fluorescent lamp, a sodium lamp, a mercury lamp, a fluorescent mercury lamp, a xenon lamp, an arc night light, a neon tube lamp, an electro luminescence (EL) lamp or a light emitting diode lamp.

The first light emitted from each of the light source 101 and 101a may be incident to the inside of the light guide plate 102 via the side surface of the light guide plate 102.

The light guide plate 102 may reflect the first light, which is incident to the inside after being emitted from the light source 101 and 101a, in the inside of the light guide plate 102 at least once, and then diffuse the reflected first light. Accordingly, the light emitted from the light source 101 and 101a may be evenly provided in all over the display panel 200. In one surface in the front direction of the light guide plate 102, the display panel 200 may be disposed, and in one surface in the rear direction of the light guide plate 102, the reflective polarizer 110 may be disposed by being mounted. The light guide plate 102 may be formed by using a material having high light transmittance, e.g. Poly Methyl Methacrylate (PMMA).

At least one light diffuser 107 may be provided on at least one side surface 102s of the light guide plate 102. The light diffuser 107 may be formed between the light source 101 and 101a, and the light guide plate 102 to allow the first light, which is emitted from the light source 101 and 101a, to be diffused and then incident to the side surface 102s of the light guide plate 102. In this case, the light diffuser 107 may be formed between the light source 101 and 101a and the light guide plate 102 by being applied or attached to the side surface 102s of the light guide plate 102. The light diffuser 107 may have a shape of a certain film, wherein the film may be formed by embedding a certain light scattering particle, e.g. zinc oxide (ZnxOx), titanium oxide (TixOx) or silicon oxide (SixOx), in a matrix formed of a polymethyl methacrylate resin or a polycarbonate.

At least one light disperser 102a may be included in the inside of the light guide plate 102. The at least one light disperser 102a may disperse the first light, which is incident to the inside of the light guide plate 102 and travels after being emitted from the light source 101, to divert the first light (L11 and L12) so that the first light is incident quickly with a relatively short distance to the reflective polarizer 110.

The light disperser 102a may be installed in at least one of one surface in the front direction and one surface in the rear direction of the light guide plate 102. For example, the light disperser 102a may be implemented by using a protrusion protruding toward the inside of the light guide plate 102, or by a groove that is formed by a cutting technology. In addition, the light disperser 102a may be implemented by a variety of means configured to disperse a light that travels in the inside of the light guide plate 102.

The substrate 105 and 105a may be provided to allow at least one light source 101 and 101a to be mounted to one surface thereof. The substrate 105 and 105a may be provided to support the at least one light source 101 and 101a. A driving power line may be formed in the substrate 105 and 105a to supply the driving power to the light source 101 and 101a. The substrate 105 and 105a may be manufactured by using a synthetic resin. The substrate 105 and 105a may be formed in the left direction and the right direction of the light guide plate 102 so that a light is incident to the opposite side surfaces of the light guide plate 102.

The reflective polarizer 110 may be formed in one surface in the rear direction of the light guide plate 102, wherein one surface of the reflective polarizer 110 may face the light guide plate 102 and the other surface of the reflective polarizer 110, which is placed in an opposite side to the one surface, may face the rear housing 12. In this case, the reflective polarizer 110 may be provided to allow the other surface thereof to be exposed to the outside via the opening 12c of the rear housing 12. According to embodiments, the other surface of the reflective polarizer 110 may be not exposed to the outside. In addition, according to an embodiment, an additional protection film may be attached to the other surface of the reflective polarizer 110. The protection film may be configured to protect the reflective polarizer 110 from an impact of the outside.

The reflective polarizer 110 may reflect a light, which travels to the rear direction that is toward the rear housing 12, among the first light that travels in the inside of the light guide plate 102, to the front direction that is a direction of the display panel 200. In this case, the reflective polarizer 110 may polarize the first light incident to the light guide plate 102 to the first polarizing axis direction, and then reflect the first light. Accordingly, the reflective polarizer 110 may emit a first polarized light corresponding to the first light.

The reflective polarizer 110 may transmit a second light that is incident in the rear direction and then emit the second light to the front direction that is the direction of the display panel 200. The second light incident in the rear direction may include a natural light that is existed in the natural state. Meanwhile, the reflective polarizer 110 may polarize a second light incident via the opening 12c of the rear housing 12 to the second polarizing axis direction and then transmit the second light. Accordingly, a second polarized light corresponding to the second light may be emitted from the reflective polarizer 110. The second polarizing axis may represent a polarizing axis that is in a different direction from the first polarizing axis, and for example, the second polarizing and the first polarizing axis may cross at right angles. In addition, the first polarizing axis may represent a polarizing axis that is perpendicular to a polarizing axis of the polarizer 216 of the display panel 200, and the second polarizing axis may represent a polarizing axis that is parallel to a polarizing axis of the polarizer 216 of the display panel 200.

According to an embodiment, the reflective polarizer 110 may be implemented by at least one of Dual Brightness Enhancement Film (DBEF™ film), diffusive reflective polarization film (DRPF), wire grid polarizer, or cholesteric liquid crystal polarizer (CLC polarizer). In addition, a variety of films or sheets, which is configured to polarize a light incident to one surface in the first polarizing axis direction and reflect the polarized light, and configured to polarize a light incident to the other surface in the second polarizing axis direction and transmit the polarized light, may be used as the reflective polarizer 110.

According to an embodiment, an additional optical plate 119 may be provided between the light guide plate 102 and the reflective polarizer 110. The optical plate 119 may include a low reflection sheet configured to reduce the reflectivity of the first light that is incident in the direction of the light guide plate 102, and a quarter wave plate configured to change polarization characteristics of at least one of the first polarized light and the second polarized light emitted from the reflective polarizer 110. The optical plate 119 may be implemented by a single sheet by using any one or both of the low reflection sheet and the quarter wave plate. In addition, the optical plate 119 may be formed by using a composite sheet in which a function of each sheet is composited.

An additional optical plate 221 may be further provided between the display panel 210 and the light guide plate 102. The optical plate 221 may include a protection sheet. The protection sheet may prevent a direct connection between the reflective polarizer 110 and the light guide plate 102, so as to protect the light guide plate 102 and the first substrate 211 of the display panel 210.

When the display apparatus 10 does not need to be transparent when the power is not applied to the light source 101, the optical plate 221 may include at least one protection sheet, at least one prism sheet, and at least one diffusion sheet, all of which are stacked. In addition, when the display apparatus 10 does not need to be transparent when the power is not applied to the light source 101, a diffusion plate (not shown) may be further provided between the reflective polarizer 110 and the light guide plate 102 as well as the above-mentioned optical plate 221.

A light, which is emitted to the front direction via an emission surface placed in the front direction of the backlight unit 100, may be incident via one surface in the rear direction of the display panel 200. In this case, the light incident via the one surface in the rear direction of the display panel 200 may be emitted to the front direction via the first substrate 211 of the display panel 200, the liquid crystal layer 213, a color converter 214, a second substrate 215, and the polarizer 216. Accordingly, the display panel 200 may display a stationary image or a moving image.

The backlight unit 100 and the display panel 200 may be provided to be connected to each other, or provided to be apart from each other with a certain distance. When the backlight unit 100 and the display panel 200 is apart from each other, a middle housing 13 may be provided between the backlight unit 100 and the display panel 200. The middle housing 13 may fix the backlight unit 100 and allow the display panel 200 to be set. In addition, the middle housing 13 may allow the display panel 200 and the backlight unit 100 to be apart from each other. The middle housing 13 may include a protrusion protruded toward the inside, and the backlight unit 100 or the display panel 200 may be fixed by the protrusion. The middle housing 13 may integrally formed with the front housing 11 or the rear housing 12, but may be omitted according to embodiments.

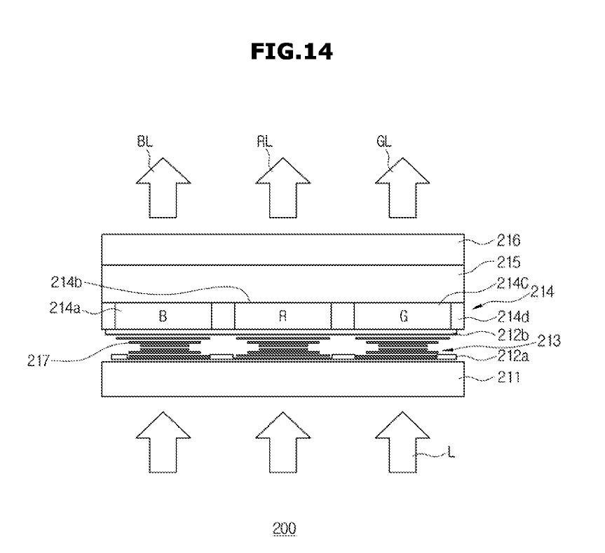

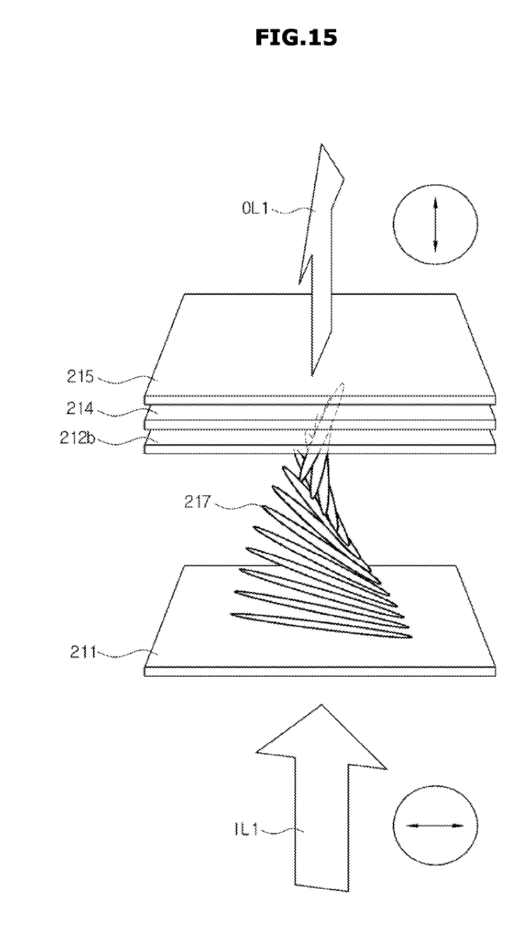

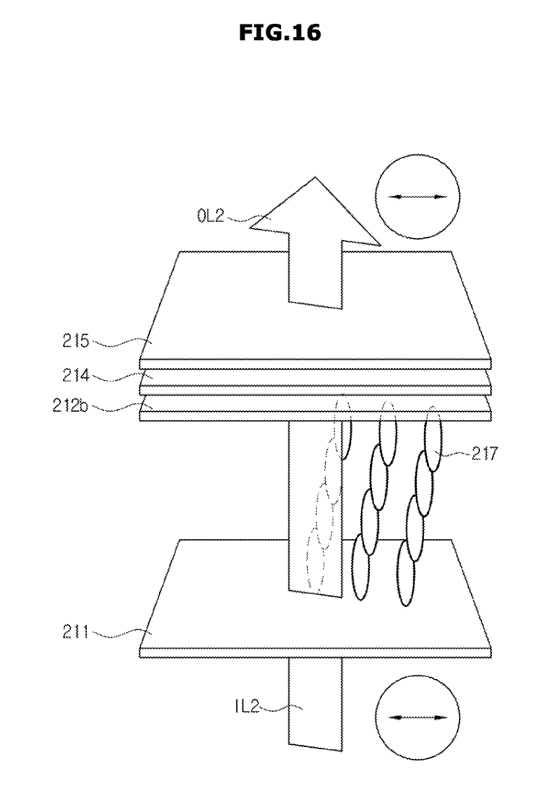

FIG. 14 is a view illustrating a display panel in accordance with an embodiment of the present disclosure, FIG. 15 is a first view illustrating an operation of liquid crystal and FIG. 16 is a second view illustrating an operation of liquid crystal.

As illustrated in FIGS. 12 to 16, the display panel 200 may include a first substrate 211, a pixel electrode 212a, a common electrode 212b, a liquid crystal layer 213, a color converter 214, a second substrate 215, and a polarizer 216.

As for the first substrate 211, one surface thereof in the rear direction may be disposed to allow a light supplied from the backlight unit 100 to be incident, and one surface thereof may be provided to allow the pixel electrode 212a to be installed. The first substrate 211 may be implemented by a transparency material, e.g. synthetic resins, e.g. acryl, or glass, so that a light irradiated from the rear direction may be transmitted. According to embodiments, the first substrate 211 may include Rigid Printed Circuit Board (RPCB), Flexible Printed Circuit Board (FPCB), or Rigid Flexible Printed Circuit Board (R-FPCB)

In this case, an additional polarization filter may be not installed in one surface in the rear direction of the first substrate 211. Since the reflective polarizer 110 polarizes a first light, which is emitted from the light source 101 disposed inside of the display apparatus 10, to the first polarizing axis and then reflects the first light, or the reflective polarizer 110 polarizes a second light, which is emitted from the outside, to the second polarizing axis and then reflects the second light, a light incident to the display panel 200 may be already polarized. Therefore, the display panel 200 may not need to polarize a light supplied from the backlight unit 100, and thus the display panel 200 may not need to further include an additional polarization filter other than the polarizer 216.

In addition to the common electrode 212b, the pixel electrode 212a installed in the first substrate 211 may control the arrangement of the liquid crystal molecules 217 inside of the liquid crystal layer 213 by applying a current to the liquid crystal layer 213 according the applied power, as illustrated in FIGS. 15 and 16, the vibration direction of the first polarized light or the second polarized light, both of which are incident to the display panel 200, may be changed or not changed depending on the arrangement of the liquid crystal molecules 217.

According to an embodiment, the pixel electrode 212a may be implemented by Thin Film Transistor (TFT). The pixel electrode 212a may be supplied with the power by being connected to the external power source. A plurality of the pixel electrode 212a may be installed in the first substrate 211, particularly installed to have a certain pattern in the first substrate 211. Each of the pixel electrode 212a may be installed in the first substrate 211 to correspond to each of the liquid crystal molecules 217 inside of the liquid crystal layer 213.

The common electrode 212b may be installed to face the pixel electrode 212a with respect to the liquid crystal layer 213. The common electrode 212b together with the pixel electrode 212a may apply a current to the liquid crystal layer 213. The common electrode 212b may be disposed to allow one surface thereof to make contact with the color converter 214.

The liquid crystal layer 213 in which a plurality of liquid crystal molecules is distributed in a high molecular matrix, may be provided between the first substrate 211 in which the pixel electrode 212a is installed, and the common electrode 212b.

The liquid crystal may represent a material in a state between a liquid and a crystal, and may include the plurality of liquid crystal molecules. The liquid crystal molecules 217 may be arranged in a plurality of columns inside of the liquid crystal layer 213. The liquid crystal molecules 217 may be disposed inside of the liquid crystal layer 213 to correspond to each photoelectric conversion element, e.g. a red photoelectric conversion element 214a, a green photoelectric conversion element 214b, and a blue photoelectric conversion element 214c. Accordingly, the liquid crystal molecules 217 may be disposed inside of the liquid crystal layer 213 to correspond to each of a certain sub-pixel of the display panel 200.

According to the orientation of the liquid crystal molecules 217, the liquid crystal layer 213 may transmit a light, which is incident via one surface in the rear direction of the display panel 200, e.g. the first substrate 211, without changing or with changing the vibration direction.

Particularly, the liquid crystal molecules 217 inside of the liquid crystal layer 213 may be arranged in various types, which is different from each other, according to the power that is applied to the pixel electrode 212a and the common electrode 212b. The liquid crystal layer 213 may change or may not change the vibration direction of a polarized light according to the arrangement of the liquid crystal molecules 217 according to whether the power is applied to the pixel electrode 212a and the common electrode 212b.

Particularly, in a case in which an electric field is not generated, the liquid crystal molecules 217 inside of the liquid crystal layer 213 may be arranged to be twisted in a spiral shape, as illustrated in FIG. 15. In this case, the liquid crystal molecules 217 may be arranged in the shape of the spiral toward a direction perpendicular to a line connecting the pixel electrode 212a to the common electrode 212b. When the liquid crystal molecules 217 are arranged to be twisted, as mentioned above, a vibration direction (a polarizing axis direction) of a light (IL1) that is incident to the liquid crystal layer 213 may be twisted by approximately 90 degree. Accordingly, the liquid crystal layer 213 may emit a light (OL1) having a polarizing axis different from the light (IL1) incident from one surface in the rear direction, via one surface in the front direction. For example, a polarizing axis direction of the first polarized light incident to the display panel 200 or a polarizing axis direction of the second polarized light may be changed.

In contrast, in a case in which an electric field is generated by the pixel electrode 212a and the common electrode 212b, liquid crystal molecules 217 inside of the liquid crystal layer 213 may be arranged in a direction approximately parallel to a line connecting the pixel electrode 212a to the common electrode 212b, according to the generated electric field, as illustrated in FIG. 16. In this case, an incident light (IL2) may pass through the liquid crystal layer 213 without changing the polarizing axis direction. Accordingly, the liquid crystal layer 213 may emit a light (0L2) having a polarizing axis identical to the light (IL2) incident in the rear direction, to the front direction. For example, a polarizing axis direction of the first polarized light incident to the display panel 200 or a polarizing axis direction of the second polarized light may be not changed.

The color converter 214 may convert a light that is incident to one surface in the rear direction and has a certain color, into a light having another color, or may output the light to the front direction without converting into a light having another color. Therefore, the color converter 214 may allow the display apparatus 10 to display a variety of colors.

The color converter 214 may be provided in a way that one surface thereof in the rear direction makes contact with the common electrode 212b or is adjacent to the common electrode 212b, and one surface thereof in the front direction is installed in the second substrate 215.

According to an embodiment, the color converter 214 may include the red photoelectric conversion element 214a converting a white-based light into a red-based light, the green photoelectric conversion element 214b converting a white-based light into a green-based light, and the blue photoelectric conversion element 214c converting a white-based light into a blue-based light when a white-based light is incident. At least one of a red-based light emitted from the red photoelectric conversion element 214a, a green-based light emitted from the green photoelectric conversion element 214b, and a blue-based light emitted from the blue photoelectric conversion element 214c may be emitted to the outside by passing through the second substrate 215 and the polarizer 216. In this case, since at least one of the red-based light, the green-based light and the blue-based light, which is emitted to the outside, is emitted to the outside with being mixed or without being mixed, the display panel 200 may allow a certain pixel to display in a certain color.

The red photoelectric conversion element 214a, the green photoelectric conversion element 214b, and the blue photoelectric conversion element 214c may be disposed to make contact with each other or to be apart a certain distance from each other. When the red photoelectric conversion element 214a, the green photoelectric conversion element 214b, and the blue photoelectric conversion element 214c are apart from each other, a barrier may be provided therebetween to prevent a connection therebetween.

The red photoelectric conversion element 214a, the green photoelectric conversion element 214b, and the blue photoelectric conversion element 214c may be arranged to have a certain pattern on the substrate 117, and each of arrangement pattern may correspond to a sub pixel of the display panel 200. The red photoelectric conversion element 214a, the green photoelectric conversion element 214b, and the blue photoelectric conversion element 214c may have the same size or a size different from each other. In addition, the number of the red photoelectric conversion element 214a, the green photoelectric conversion element 214b, and the blue photoelectric conversion element 214c, all of which are installed in the same substrate 117, may be different from each other. For example, the number of the red photoelectric conversion element 214a and the green photoelectric conversion element 214b may be larger than the number of the blue photoelectric conversion element 214c.

At least one of the above-mentioned red photoelectric conversion element 214a, the green photoelectric conversion element 214b, and the blue photoelectric conversion element 214c may be implemented by quantum dot for the conversion of the color.

According to another embodiment, a color converter 214 may include a red photoelectric conversion element 214a converting a blue-based light into a red-based light, a green photoelectric conversion element 214b converting a blue-based light into a green-based light, and a blue photoelectric conversion element (not shown) transmitting a blue-based light when a blue-based light is incident to the second polarizer 118. The red photoelectric conversion element 214a, the green photoelectric conversion element 214b, and the blue photoelectric conversion element 214c may be implemented by a red color filter, a green color filter, and a blue color filter, respectively.

A light, which is converted in the color converter 214 and then emitted, may be incident to the polarizer 216 by passing through the second substrate 215.

The second substrate 215 may be provided to allow each color conversion element of the color converter 214, e.g. the red photoelectric conversion element 214a, the green photoelectric conversion element 214b, and the blue photoelectric conversion element 214c, to be set in one surface in the front direction. The second substrate 215 may be implemented of a transparent material to transmit a red light, a green light, and a blue light emitted from the color converter 214. For example, the second substrate 215 may be manufactured by using e.g. synthetic resins, e.g. acryl, or glass.

The polarizer 216 may be installed in one surface in the front direction of the second substrate 215, and may polarize an incident light. According to embodiments, the polarizer 216 may be implemented by a horizontal polarization filter or a vertical polarization filter.

According to an embodiment, the polarizer 216 may polarize an incident light to the second polarizing axis direction. The second polarizing axis direction may represent a direction in which a light incident via one surface in rear direction of the reflective polarizer 110 is polarized. In other words, the polarizing axis direction of the polarizer 216 may be different from a polarizing axis direction of the first polarized light that is emitted from the light source 101 and emitted by being reflected by the reflective polarizer 110, and may be the same as a polarizing axis direction of the second polarized light that is incident via one surface in the rear direction of the reflective polarizer 110.

When a light is incident to the polarizer 216, the incident light may pass or may not pass through the polarizer 216 according to a polarizing axis direction of the incident light, and thus a certain light may pass or may not pass through the polarizer 216. Therefore, the display panel 200 may display an image having a variety of colors or may not display any image.

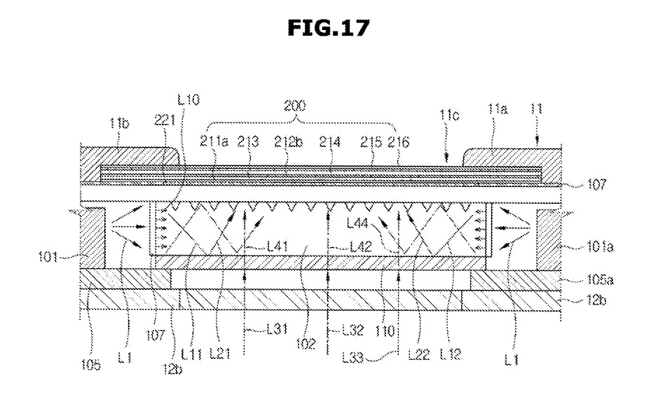

Hereinafter a process in which the display apparatus 10 displays an image when a first light is emitted from the light source 101 embedded in the display apparatus 10 will be described with reference to FIGS. 17 to 20.

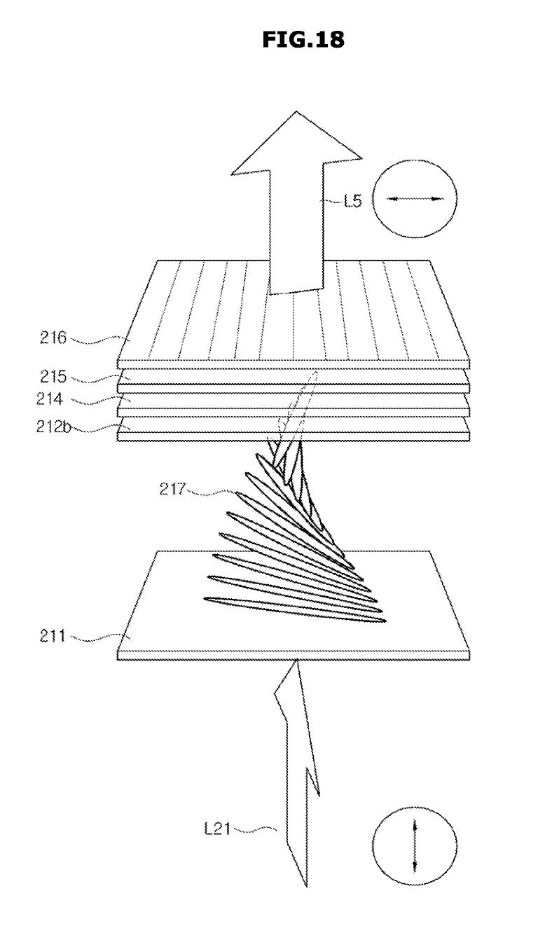

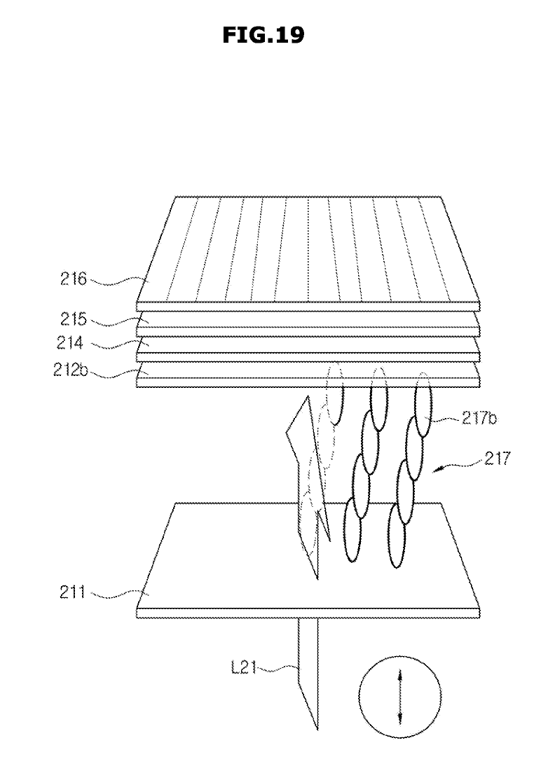

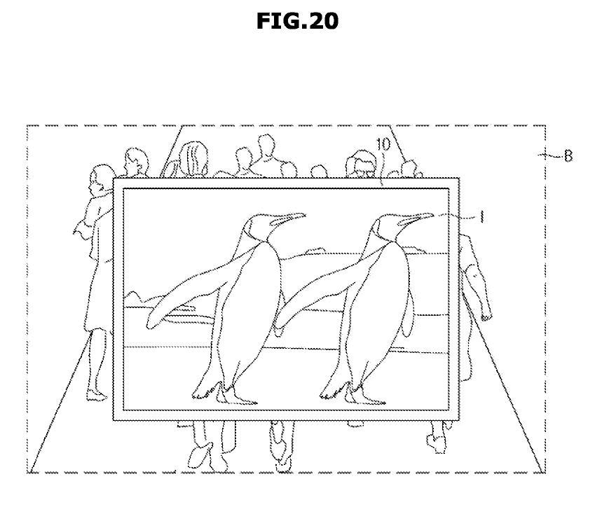

FIG. 17 is a view illustrating a process in which a first polarized light is incident to a display panel when a first light is irradiated from a light source. FIG. 18 is a view illustrating an operation of liquid crystal when an image is displayed according to a first polarized light and FIG. 19 is another view illustrating an operation of liquid crystal when an image is displayed according to a first polarized light. FIG. 20 is a view illustrating an image that is displayed when a first light is emitted from a light source.

As illustrated in FIG. 17, when a first light (L1) is incident from the light source 101 since the power is applied to the light source 101, the incident light may be incident to one surface of the reflective polarizer 110 while traveling in the light guide plate 102 (L11). The reflective polarizer 110 may polarize the incident first light (L11) to the first polarizing axis and then reflect the first light to the inside of the light guide plate 102. Accordingly, a first polarized light (L21) may be emitted via one surface of the reflective polarizer 110, and the first polarized light (L21) may be incident to the display panel 200 by passing through the light guide plate 102. Meanwhile, a light (L31 to L33) delivered from the external light source may be incident to the other surface of the reflective polarizer 110 through an opening 12c formed in the rear housing 12 of the display apparatus 10. The reflective polarizer 110 may polarize the light (L31 to L33) delivered from the external light source to the second polarizing axis direction and then transmit the light (L31 to L33). Accordingly, a second polarized light (L41 to L43) may be emitted via one surface of the reflective polarizer 110, and then the second polarized light (L41 to L43) may be incident to the inside of the light guide plate 102. The second polarized light (L41 to L43) may pass through the light guide plate 102 and then incident to the display panel 200, as the same as the first polarized light (L21). In this case, the second polarized light (L41 to L43) may have an intensity that is relatively weaker than that of the first polarized light (L21).

As illustrated in FIG. 18, when the power is not applied to the pixel electrode 212a and the common electrode 212b, the liquid crystal molecules 217 may be arranged in various directions. The first polarized light (L21) that is incident to the display panel 200 and vibrated in the first polarizing axis direction may be incident to the liquid crystal layer 213 by passing through the first substrate 211, and a polarizing axis thereof may be twisted by the liquid crystal molecules 217 arranged in various directions. In this case, a first polarized light (L5) may pass through the liquid crystal layer 213 since a polarizing axis direction thereof is twisted in the second polarizing axis direction, which is different from the first polarizing axis direction. The first polarized light (L5), which passes through the liquid crystal layer 213 and twisted to the second polarizing axis direction, may be incident to the polarizer 216 by passing through the color converter 214 and the second substrate 215. Since the polarizer 216 transmits a light in the second polarizing axis direction as mentioned above, the first polarized light (L5), which is twisted to the second polarizing axis direction, may be emitted to the outside by passing through the polarizer 216

Meanwhile, the polarizing axis of the second polarized light (L41 to L43) may be also twisted by passing through the liquid crystal layer 213. Therefore, the second polarized light (L41 to L43) may travel to the first polarizing axis direction while vibrating. Since the polarizer 216 transmits a light in the second polarizing axis direction, as mentioned above, the second polarized light (L41 to L43) that is twisted in the first polarizing axis direction may not pass through the polarizer 216. Therefore, the second polarized light (L41 to L43) may be blocked by the polarizer 216.

As illustrated in FIG. 19, when the power is applied to the pixel electrode 212a and the common electrode 212b, the liquid crystal molecules 217 may be arranged in a certain direction according to an electric field formed by the pixel electrode 212a and the common electrode 212b. When the liquid crystal molecules 217 is arranged in a certain direction, a first light (L21) incident to the liquid crystal layer 213 may pass through the liquid crystal layer 213 without changing a polarizing axis thereof. In other words, the first light (L21) passing through the liquid crystal layer 213 may travel while vibrating to the first polarizing axis direction that is the same as a polarizing axis direction when being incident to the liquid crystal layer 213. The first light (L21) passing through the liquid crystal layer 213 may be incident to the polarizer 216 by passing through the color converter 214 and the second substrate 215. Since the polarizer 216 transmits a light in the second polarizing axis direction, as mentioned above, the first polarized light (L21) vibrating in the first polarizing axis direction may not pass through the polarizer 216. Therefore, the display panel 200 may not emit a light corresponding to the first polarized light (L21) to the outside.

In this case, since the second polarized light (L41 to L43) still travels while vibrating in the second polarizing axis direction, the second polarized light (L41 to L43) may pass through the polarizer 216. However, although the second polarized light (L41 to L43) is emitted via the display panel 200, a viewer may visually less recognize or rarely recognize the emitted second polarized light (L41 to L43) due to the emitted first polarized light (L21), since the intensity of the second polarized light (L41 to L43) is weaker than that of the first polarized light (L21).

Since the first polarized light (L21) passes through or does not pass through the liquid crystal layer 213 according to the arrangement state of the liquid crystal molecules 217 inside of the liquid crystal layer 213, as mentioned above, a light passing through a certain photoelectric conversion element corresponding to a certain sub pixel, i.e. at least one of the red photoelectric conversion element 214a, the green photoelectric conversion element 214b, and the blue photoelectric conversion element 214c, may be emitted to the outside, and thus the display apparatus 10 may output a certain image (I) as illustrated in FIG. 20. In this case, since a second light delivered from a background (B) rarely passes through the display panel 200 of the display apparatus 10, the background (B) may be rarely displayed on the display panel 200. Therefore, the display apparatus 10 may rarely be transparent.

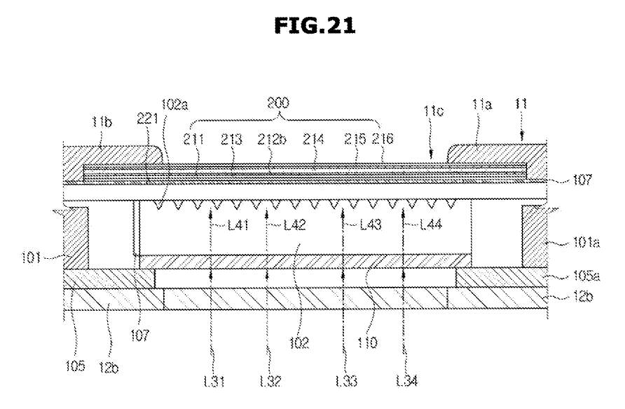

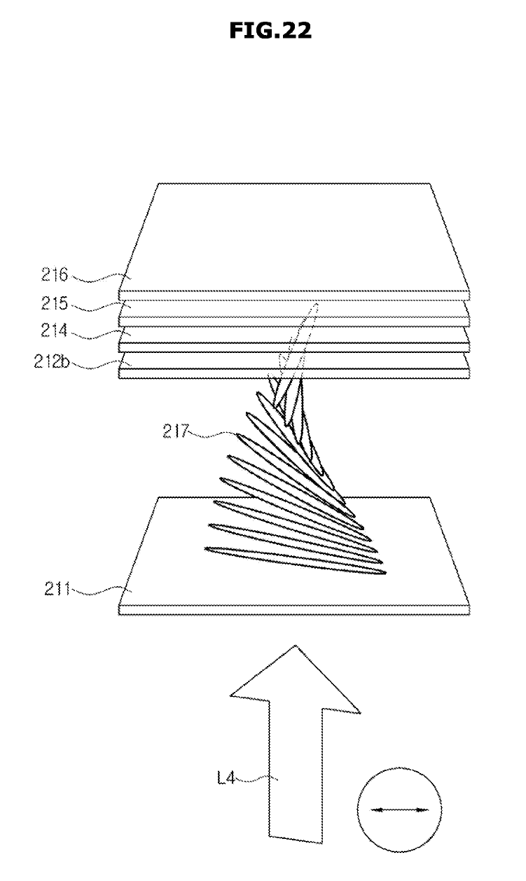

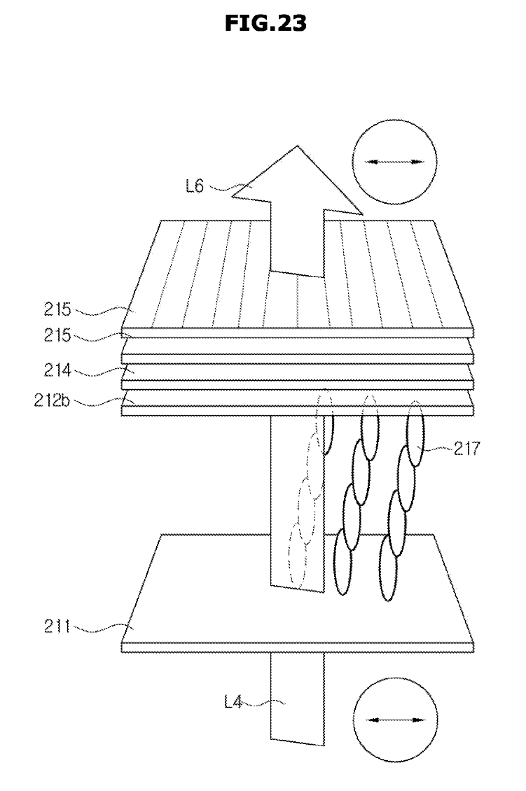

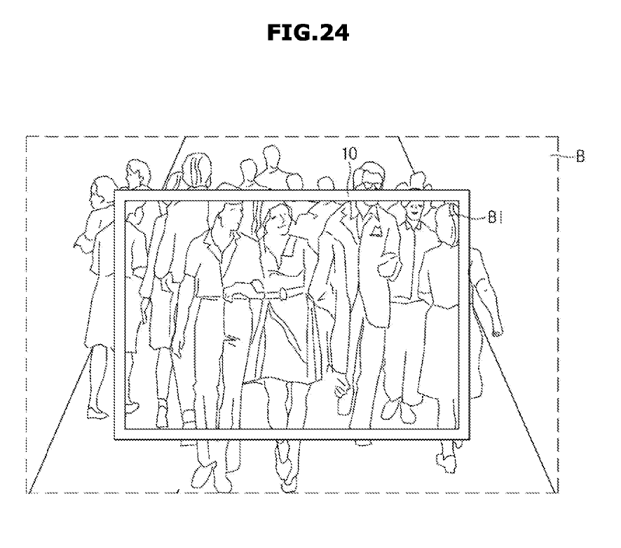

FIG. 21 is a view illustrating a process in which a second polarized light is incident to a display panel when a second light is incident to a background. FIG. 22 is another view illustrating an operation of liquid crystal when an image is displayed according to a second polarized light and FIG. 23 is another view illustrating an operation of liquid crystal when an image is displayed according to a second polarized light. FIG. 24 is a view illustrating an image that is displayed when a second polarized light is incident.

As illustrated in FIG. 21, when the power is not applied to the light source 101, a light (L31 to L34) delivered from the external light source may be incident to one surface in the rear direction of the reflective polarizer 110 via the opening 12c formed in the rear housing 12 of the display apparatus 10. The reflective polarizer 110 may polarize the light (L31 to L34) delivered from the external light source to the second polarizing axis direction, as mentioned above, and then transmit the light (L31 to L34). Accordingly, a second polarized light (L41 to L44) corresponding to the light (L31 to L34) delivered from the external light source may be emitted via one surface of the reflective polarizer 110. The emitted second polarized light (L41 to L44) may be incident to the inside of the light guide plate 102 and then incident to the display panel 200 by passing through the light guide plate 102.

As illustrated in FIG. 22, when the power is not applied to the pixel electrode 212a and the common electrode 212b, the liquid crystal molecules 217 may be arranged in various directions, and a polarizing axis of the second polarized light (L4) may be twisted while passing through the liquid crystal layer 213. The second polarized light (L4) may travel while vibrating in the first polarizing axis direction. When the polarizer 216 transmits a light in the second polarizing axis direction, the second polarized light (L4) that is twisted in the first polarizing axis direction may not pass through the polarizer 216, and thus the display panel 200 may not display any image (I) or a background (B).

As illustrated in FIG. 23, when the power is applied to the pixel electrode 212a and the common electrode 212b, the liquid crystal molecules 217 may be arranged in a certain direction according to an electric filed formed by the pixel electrode 212a and the common electrode 212b. When the liquid crystal molecules 217 is arranged in a certain direction, the second polarized light (L4) incident to the liquid crystal layer 213 may pass through the liquid crystal layer 213 without changing a polarizing axis thereof and then incident to the polarizer 216. As mentioned above, since the polarizer 216 transmits a light in the second polarizing axis direction, the second polarized light (L4) may pass through the polarizer 216.

When the second polarized light (L41 to L43) passes through the display panel 200 and then emitted to the outside, as mentioned above, a background (B1) may be displayed on the display panel 200 since the second light (L3) delivered from the background (B) passes through the display panel 200 of the display apparatus 10. In other words, the display panel 200 may be transparent when the power is not applied to the light source 101, and thus the display apparatus 10 may display the background (B1) instead of the image (I).

Hereinbefore an embodiment of the display apparatus 10 to which the backlight unit 100 is applied is described, but is not limited thereto. The display apparatus 10 to which the backlight unit 100 is applied may include a mobile terminal device, e.g. a cellular phone, a smart phone, a tablet PC, a laptop, a navigation terminal device, or a personal digital assistant device. The display apparatus 10 to which the backlight unit 100 is applied may include a television set, a computer monitor device, or an audio/video system. In addition, the display apparatus 10 to which the backlight unit 100 is applied may include an outdoor advertising board, a window of a building, or a glass door. The display apparatus 10 to which the backlight unit 100 is applied may include a windshield of a vehicle, and a window installed in a door of a vehicle, both of which are configured to display an image, e.g. a text, a symbol, and a picture. The display apparatus 10 to which the backlight unit 100 is applied may include a variety of devices that is needed to display an image or to be transparent as needed.

As is apparent from the above description, according to the proposed backlight unit and the display apparatus, since a single polarizing plate may be installed in a display panel, the loss of the light caused by a plurality of polarizing plates may be reduced and thus the visibility of the display apparatus may be improved.

Since a transparent state is implemented without applying the power to the display panel, it may be possible to implement a transparent display apparatus having relatively clearer and more transparent characteristics.

Since a diffused light is incident to a light guide plate, a bright line may be removed and thus the visibility of the display apparatus may be improved.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A backlight unit comprising:
a light guide plate; and
a reflective polarizer configured to polarize a first light to a first polarizing axis direction and reflect the first light, the first light being from a direction oblique to a front surface of the light guide plate, and to polarize a second light to a second polarizing axis direction, which is different from the first polarizing axis direction, and transmit the second light, the second light being from a direction orthogonal to the front surface of the light guide plate.

2. The backlight unit of claim 1 further comprising:
a light source configured to emit the first light and allow the first light to be directed toward a side surface of the light guide plate.

3. The backlight unit of claim 2 further comprising:
a light diffuser provided between the light source and the light guide plate, and configured to diffuse the first light.

4. The backlight unit of claim 1 wherein
the reflective polarizer polarizes the first light to the first polarizing axis direction and then reflects the first light to the inside of the light guide plate when the first light is incident to a first surface toward a direction of the light guide plate.

5. The backlight unit of claim 4 wherein
the reflective polarizer polarizes the second light to the second polarizing axis direction, which is different from the first polarizing axis direction, and then allows the second light to be incident to the inside of the light guide plate when the second light is incident to a second surface placed in an opposite side to the first surface.

6. The backlight unit of claim 5 wherein
the second surface of the reflective polarizer is exposed to the outside.

7. The backlight unit of claim 1 wherein
the light guide plate comprises an emission surface as the front surface configured to emit a first light, which is polarized, to a direction of a display panel, wherein the reflective polarizer is installed in a rear surface of the light guide plate on an opposite side to the emission surface.

8. The backlight unit of claim 7 wherein
the light guide plate comprises a disperser formed in the emission surface of the light guide plate and configured to disperse the first light incident to the light guide plate, and allow the first light to be toward the direction of the reflective polarizer.

9. The backlight unit of claim 1 further comprising:
an optical plate provided between the light guide plate and the reflective polarizer.

10. The backlight unit of claim 9 wherein
the optical plate comprises at least one of a quarter wave plate configured to generate an optical path difference between two polarization components of the first light or the second light, and a low reflection sheet configured to reduce a reflectivity degree of the first light incident.

11. A display apparatus comprising:
a light guide plate; and
a reflective polarizer configured to polarize a first light to a first polarizing axis direction and then reflect the first light, the first light being from a direction oblique to a front surface of the light guide plate, and to polarize a second light to a second polarizing axis direction, which is different from the first polarizing axis direction, and then transmit the second light, the second light being from a direction orthogonal to the front surface of the light guide plate.

12. The display apparatus of claim 11 further comprising:
a display panel unit to which a first polarized light or a second polarized light passing through the light guide plate and being polarized is incident.

13. The display apparatus of claim 12 further comprising:
a polarizer configured to perform a polarization in a polarizing axis direction identical to the second polarized light.

14. The display apparatus of claim 12 wherein
the display panel unit displays an image when a first light is emitted from the light source according to the application of the power, and display the second light by transmitting the second light when the power is not applied to the light source.

15. The display apparatus of claim 11 wherein
the display apparatus comprises a cellular phone, a smart phone, a tablet PC, a computer monitor device, a lap top, a navigation terminal device, a personal digital assistant device, an outdoor advertising board, a window of a vehicle, or a window of a building.

16. A backlight unit comprising:
a light guide plate provided with an emission surface configured to emit a light to the outside; and
a reflective polarizer provided in a way that a first surface contacts a rear surface of the light guide plate, the rear surface being opposite to the emission surface, and when the first light passing through the light guide plate is incident to the first surface, the reflective polarizer is configured to polarize the incident first light to the first polarizing axis direction and then reflect the first light to the inside of the light plate guide.

17. The backlight unit of claim 16 wherein
the reflective polarizer polarizes a second light to a second polarizing axis direction and then transmits the second light when the second light is incident to the second surface that is on an opposite side to the first surface.
